(19) United States
(12) Patent Application Publication
(10) Pub. No.: US 2008/0150705 A1
(43) Pub. Date: Jun. 26, 2008

(54) Contaminant detecting touch sensitive element

(75) Inventor: Ziyad K. Al-Wakeel, Toronto (CA)

Correspondence Address: Helen Odar Wolstoncroft;Tyco Electronics Corporation, Suite 140, 4550 New Linden Hill Road, Wilmington, DE, 19808-2952, US

(73) Assignee: Tyco Electronics Canada, Ltd.

(21) Appl. No.: 11/642,161

(22) Filed: Dec. 20, 2006

(51) Int. Cl. G08B 6/00

(52) U.S. Cl. 340/407.2

(57) ABSTRACT

A touch sensitive control interface for a controlled device includes a panel defining an interface area configured to selectively input command instructions of an operator of the device. The panel includes a primary touch sensor portion configured to receive an activation signal and a secondary touch sensor portion configured to receive a contamination signal. The primary and secondary touch sensor portions are normally isolated from one another, and the primary and secondary touch sensor portions are coupled to one another upon a presence of a contaminant such that the primary touch sensor portion senses the contamination signal.

### BACKGROUND OF THE INVENTION

This invention relates generally to touch sensitive control interfaces, and more particularly, to touch sensitive elements for environments vulnerable to spills and contaminants.

Due to their convenience and reliability, touch sensitive control interfaces are increasingly being used in lieu of mechanical switches for various products and devices. Touch sensitive control interfaces are used in a wide variety of exemplary applications such as appliances (e.g., stoves and cooktops), industrial devices such as machine controls, cash registers and check out devices, and even toys. The associated devices may be operated by pressing predefined areas of the interface with a finger, and typically include a controller coupled to the interface to operate mechanical and electrical elements of the device in response to user commands entered through the touch control interface.

Various types of touch technologies are available for use in touch control interfaces, including but not limited to touch sensitive elements such as capacitive sensors, membrane switches, and infra-red detectors. It has been noted, however, that such touch sensitive elements are subject to inadvertent activation attributable to a foreign object or deposit that touches the interface in the vicinity of the touch sensitive elements. It has been observed, for example, that foreign materials splashed, spilled, deposited or otherwise accidentally applied to the control interface can actuate known touch sensitive elements. This is a particularly undesirable result when the touch sensitive elements are associated, for example, with an appliance heating element or a heavy piece of machinery, yet such splashes, spills, and unintentional application of foreign material are not uncommon to cooking environments and manufacturing environments.

A need remains for an efficient and reliable control system for a touch sensitive control interface that has the ability to identify when a contaminant is deposited on a surface of the touch sensitive control interface.

### BRIEF DESCRIPTION OF THE INVENTION

In one aspect, a touch sensitive control interface is provided for a controlled device, wherein the control interface includes a panel defining an interface area configured to selectively input command instructions of an operator of the device. The panel includes a primary touch sensor portion configured to receive an activation signal and a secondary touch sensor portion configured to receive a contamination signal. The primary and secondary touch sensor portions are normally isolated from one another, and the primary and secondary touch sensor portions are coupled to one another upon a presence of a contaminant such that the primary touch sensor portion senses the contamination signal.

In another aspect, a touch sensitive control system is provided for controlling a device, wherein the control system includes an interface having a touch sensitive element configured to receive an activation signal and a contaminant sensor portion configured to receive a contamination signal. The contaminant sensor portion is normally isolated from the touch sensitive element, and the contaminant sensor portion is coupled to the touch sensitive element upon a presence of a contaminant overlapping each of the touch sensitive element and the contaminant sensor portion. The touch sensitive element is configured to send an output signal being characterized by the activation signal when no contaminant is present and being characterized by both the activation signal and the contamination signal when a contaminant is present. The control system also includes a controller electrically connected to the primary touch sensor portion and receiving the output signal therefrom. The controller is operatively responsive to the output signal.

In a further aspect, a device having a touch sensitive control system is provided, wherein the device includes an interface having a touch sensitive element configured to receive an activation signal and a contaminant sensor portion configured to receive a contamination signal. The contaminant sensor portion is normally isolated from the touch sensitive element, and the contaminant sensor portion is coupled to the touch sensitive element upon a presence of a contaminant overlapping each of the touch sensitive element and the contaminant sensor portion. The touch sensitive element is configured to send an output signal being characterized by the activation signal when no contaminant is present and being characterized by both the activation signal and the contamination signal when a contaminant is present. The device also includes a controller electrically connected to the primary touch sensor portion and receiving the output signal therefrom. The controller is configured to send a control signal responsive to the output signal. An operating element is operatively coupled to the controller and receives the control signal.

### BRIEF DESCRIPTION OF THE DRAWINGS

FIG. 1 is a schematic block diagram of an exemplary touch sensitive control system for a device.

FIG. 2 is a top plan view of an exemplary control panel for the control system shown in FIG. 1.

FIG. 3 is a schematic view of the control panel shown in FIG. 2.

FIG. 4 is an exemplary signaling chart of an exemplary primary signal sent to the control panel shown in FIG. 3.

FIG. 5 an exemplary signaling chart of an exemplary secondary signal sent to the control panel shown in FIG. 3.

### DETAILED DESCRIPTION OF THE INVENTION

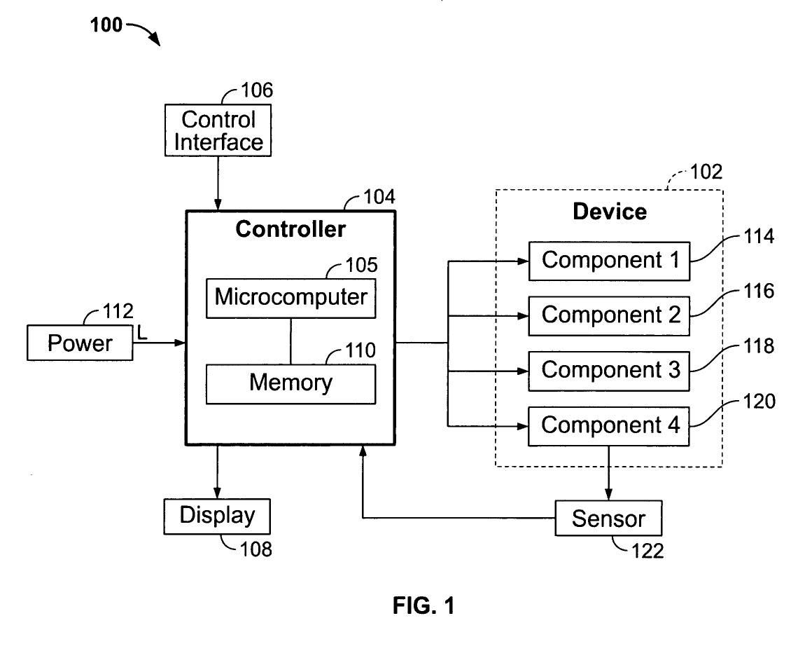

FIG. 1 is a schematic block diagram of an exemplary touch sensitive control system 100 for a device 102, which in various embodiments may be an appliance, an industrial machine or any other device in which a touch sensitive control interface is desirable, and for which inadvertent actuation of the device 102 is a concern.

In an exemplary embodiment, the control system 100 includes a controller 104 which may, for example, include a microcomputer or other processor 105 coupled to a user control interface 106 including one or more touch sensitive elements as described further below. An operator may enter control parameters, instructions, or commands and select desired operating algorithms and features of the device 102 via an input at the user control interface 106. In one embodiment a display or indicator 108 is coupled to the controller 104 to display appropriate messages and/or indicators to the operator of the device 102 to confirm user inputs and operation of the device 102. A memory 110 is also coupled to the controller 104 and stores instructions, calibration constants, and other information as required to satisfactorily complete a selected user instruction or input. Memory 110 may, for example, be a random access memory (RAM). In alternative embodiments, other forms of memory could be used in conjunction with RAM memory, including but not limited to flash memory (FLASH), programmable read only memory (PROM), and electronically erasable programmable read only memory (EEPROM).

Power to control system 100 is supplied to controller 104 by a power supply 112 configured to be coupled to a power line L. Analog to digital and digital to analog converters (not shown) are coupled to the controller 104 to implement controller inputs and executable instructions to generate controller outputs to operative components 114, 116, 118 and 120 of the device 102 according to known methods. While four components 114, 116, 118, and 120 are illustrated in FIG. 1, it is recognized that greater or fewer components may be employed.

In response to manipulation of the control interface 106, the controller 104 monitors various operational factors of the device 102 with one or more sensors or transducers 122, and the controller 104 executes operator selected functions and features according to various methods.

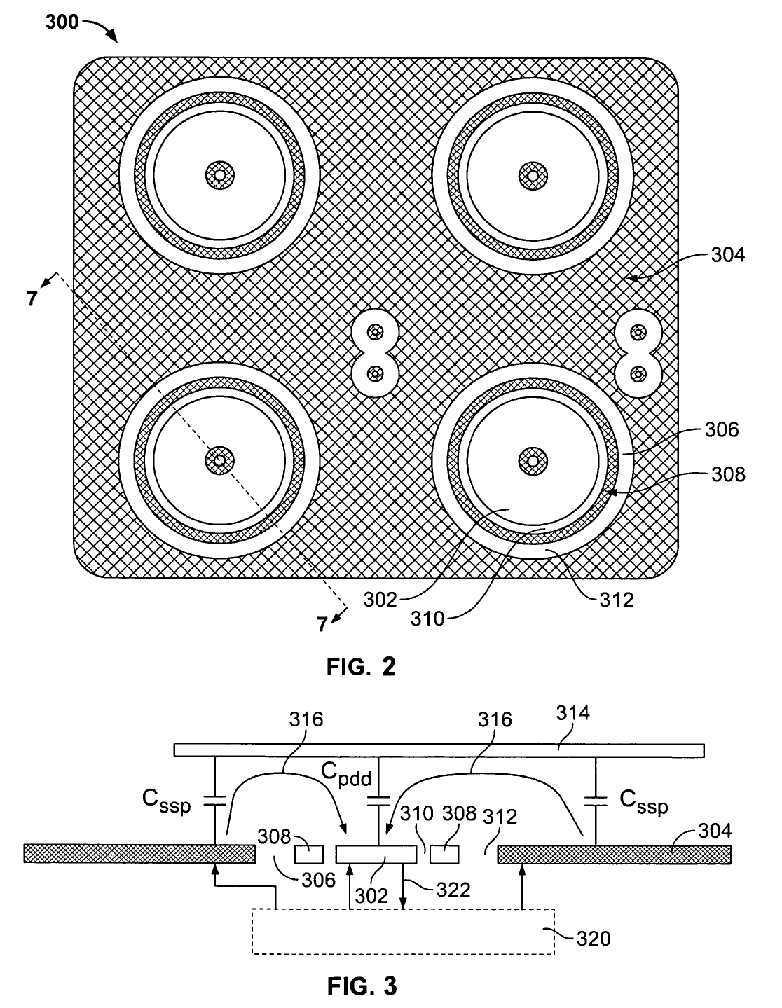

FIG. 2 is a top plan view of an exemplary control panel 300 for the control system 100 (shown in FIG. 1). The control panel 300 is part of the control interface 106 (shown in FIG. 1) and defines an interface area for manipulation by a user to enter control commands and instructions for the device 102 (shown in FIG. 1). In different embodiments, the panel 300 may be mounted proximate the operative components 114-120 (e.g., heating elements) of the device 102 (such as in a cooking appliance), or the panel 300 may be located in a remote location from the components 114-120 (such as for moving components of an industrial machine).

The control panel 300 includes touch sensitive elements 302 (sometimes referred to as sensor element or sensors) and a contaminant sensor element 304. The touch sensitive elements 302 define a primary activation area or portion and provide inputs to the controller 104 (shown in FIG. 1) upon a touch event by a user. The touch sensitive elements 302 are of a particular size and shape for convenient activation with, for example, a user's fingertip. In the illustrated embodiment, the touch sensitive elements 302 are circular. Alternatively, the touch sensitive elements 302 may have a different shape, such as an elongated shape, an oval shape, a polygonal shape, an irregular shape, and the like. Optionally, the touch sensitive elements 302 may be capacitive touch sensing elements. Alternatively, the touch sensitive elements 302 may be other touch sensing elements such as membrane switch assemblies, infrared detectors, or other known tactile or touch switches familiar to those in the art. The touch sensitive elements 302 may be arranged in any desired orientation relative to one another within the confines of the panel 300, and greater or fewer touch sensitive elements 302 may be employed in the panel 300. It is further recognized that the benefits described herein may accrue to control systems having more than one control panel 300 with one or more touch sensitive elements, such as elements 302.

The contaminant sensor element 304 defines a contaminant detection area proximate to or adjacent the touch sensitive elements 302. Optionally, the contaminant sensor element 304 may be a circuit board having traces (not shown), such as copper traces, arranged in a predetermined pattern. The traces may be elongated, thin traces extending substantially across the panel 300 or substantially between adjacent touch sensitive elements 302. Multiple traces may be arranged between adjacent touch sensitive elements 302. In an alternative embodiment, discrete contact elements may be provided rather than traces, and multiple contact elements may be positioned between adjacent touch sensitive elements 302. The traces or contact elements may be arranged in a predetermined pattern, such as a grid pattern across a substantial portion of the panel 300. Alternatively, the traces or contact elements may be arranged in another pattern, such as a pattern that surrounds each touch sensitive element 302, such as concentric rings or polygons surrounding each touch sensitive element 302. The traces may be discontinuous such that the traces do not completely surround the touch sensitive elements 302. In one alternative embodiment, an outer surface or top surface of the contaminant sensor element 304 may define a single contact extending substantially along the entire contaminant detection area (e.g. a solid contact surface).

In the illustrated embodiment, the panel 300 includes a single contaminant sensor element 304 that completely surrounds each of the touch sensitive elements 302. Alternatively, multiple contaminant sensor elements, such as element 304, may be provided. Optionally, a single contaminant sensor element 304 may be associated with a single touch sensitive element 302. Alternatively, a single contaminant sensor element 304 may be associated with multiple touch sensitive elements 302. Alternatively, multiple contaminant sensor elements 304 may be associated with a single touch sensitive element 302.

The contaminant sensor element 304 includes multiple openings 306 therethrough and the touch sensitive elements 302 are positioned within the openings 306. Optionally, a ground pad 308 may be positioned between each touch sensitive element 302 and the contaminant sensor element 304 to electrically isolate the touch sensitive elements 302 from the contaminant sensor element 304. An isolation gap 310 may also be provided between the ground pad 308 and the corresponding touch sensitive element 302. Likewise, an isolation gap 312 may be provided between and the ground pad 308 and the contaminant sensor element 304.

FIG. 3 is a schematic view of the control panel 300 shown in FIG. 2, illustrating an exemplary positioning of the touch sensitive elements 302 within the openings 306 of the contaminant sensor element 304. The touch sensitive elements 302 are illustrated as being coplanar with the contaminant sensor element 304, however, alternative embodiments may provide the touch sensitive elements 302 in either an elevated or a recessed position with respect to the contaminant sensor element 304. The ground pad 308 is positioned between the touch sensitive element 302 and the contaminant sensor element 304. Optionally, the ground pad 308 may be coplanar with the touch sensitive element 302.

A contaminant 314 is illustrated in FIG. 3 deposited on the panel 300. The contaminant 314 overlays at least a portion of the contaminant sensor element 304 and at least a portion of the touch sensitive element 302, and interconnects the elements 302, 304. The contaminant 314 is defined as any conductive body, for example a fluid such as water, that contaminates the panel 300. Contamination is defined as any spill of a conductive body covering a portion, or the whole, of the panel 300. Optionally, a film or cover (not shown) may overlay the touch sensitive element 302 and the contaminant sensor element 304 and define an outer surface or top surface of the panel 300. The cover may be used to protect the touch sensitive element 302 and the contaminant sensor element 304 from the contaminant 314 when the contaminant 314 is deposited on the cover. As further illustrated in FIG. 3, when the contaminant 314 overlays the cover, a capacitive circuit is created between the touch sensitive element 302 and the contaminant 314. Similarly, a capacitive circuit is created between the contaminant sensor element 304 and the contaminant 314. When the contaminant 314 overlays both the touch sensitive element 302 and the contaminant sensor element 304, a capacitive circuit is created that functions as a coupling path 316 between the contaminant sensor element 304 and the touch sensitive element 302. Optionally, the contaminant 314 may be said to overlay the elements when the contaminant 314 is deposited adjacent to the touch sensitive element 302 and/or the contaminant sensor element 304 such that the capacitive circuit is created therebetween.

The touch sensitive element 302 and the contaminant sensor element 304 are each configured to receive control signals. In the illustrated embodiment, both the touch sensitive element 302 and the contaminant sensor element 304 are coupled to a controller 320 that sends the control signals to the respective elements 302, 304. The touch sensitive element 302 receives a primary or activation signal that is used to indicate when a touch event by a user is occurring at the touch sensitive element 302. The contaminant sensor element 304 receives a secondary or contaminant signal that is used to indicate when a contamination has occurred at the panel 300. The secondary signal has a different signal characteristic than the primary signal so that the controller 320 can detect the respective signals. Optionally, the controller 320 may be similar to the controller 104 illustrated in FIG. 1. In one embodiment, a signal generator (not shown) may be provided, in lieu of or in addition to the controller 320, for generating the signals. The signal generator may be part of the controller 320 or may be a separate device. The touch sensitive element 302 and the contaminant sensor element 304 may receive signals from different controllers or different signal generators in an alternative embodiment.

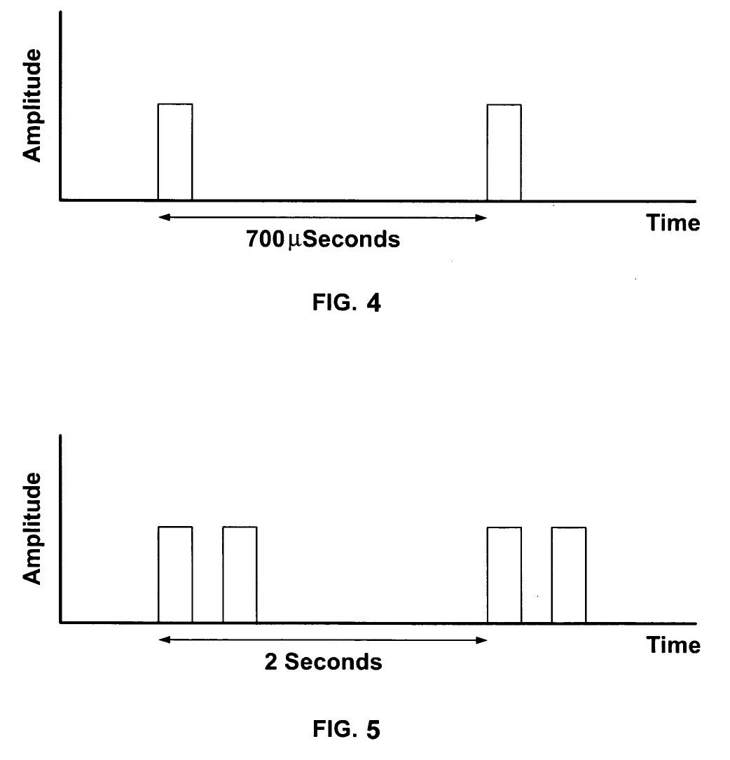

In the illustrated embodiment, the controller 320 receives an output signal 322 from the touch sensitive element 302 to monitor the status of the panel 300. For example, the output signal 322 may constitute a touch, no contamination signal; the output signal 322 may constitute a touch, contamination signal; the output signal 322 may constitute a no touch, contamination signal; or the output signal 322 may constitute a no touch, no contamination signal. The controller 320 responds differently based on the type of output signal 322 received. For example, when a touch, no contamination signal is received, the controller 320 may activate an associated device; when a no touch, contamination signal or a no touch, no contamination signal is received, the controller 320 may cause the associated device to become inactive; or when a no touch, no contamination signal is received, the controller 320 may do nothing to the associated device. As is evident from the above description, the output signal 322 corresponds, either directly or indirectly, to the signals received at the panel 300, such as the primary and secondary signals. A signal characteristic of the output signal 322 may be based on the signal characteristic of the primary signal, the signal characteristic of the secondary signal, a touch by a user, and contamination. Examples of the primary and secondary signals are illustrated in FIGS. 4 and 5, respectively, which will be described below.

FIG. 4 is an exemplary signaling chart of an exemplary primary signal sent to the control panel shown in FIG. 3. FIG. 5 is an exemplary signaling chart of an exemplary secondary signal sent to the control panel shown in FIG. 3. Differences between the signal characteristics of the primary and secondary signals may be identified when the signaling charts are compared with one another.

The exemplary signals illustrated in FIGS. 4 and 5 are pulsed signals. The signal characteristic differences between the primary and secondary signals illustrated include different pulse patterns, different frequencies, different pulse widths and different intervals between successive pulsed signals. As these signals affect the output signal 322 (shown in FIG. 3), the controller 320 is able to monitor the status of the panel 300 based on the signal characteristic differences between the primary and secondary signals. Other examples of signal characteristic differences may include a difference in amplitude, a difference in a shape of the signal, a difference in the type of signal, a different in signal duration, a difference in signal phase, and the like. Optionally, just one of the signal characteristic differences may be used to detect the type of output signal.

As indicated above, one signal characteristic difference illustrated in FIGS. 4 and 5 relates to the signal patterns. One signal pattern may include a single pulse followed by a predetermined wait time, and then another single pulse, such as the pattern illustrated in FIG. 4. Another signal pattern may include a series of pulsed signals, followed by a predetermined wait time, and then another series of pulses. The series of pulses may be two pulses, such as that illustrated in FIG. 5, or the series may include more than two pulses. Additionally, the pulses within the series may be varied according to another signal characteristic, such as amplitude.

Another signal characteristic difference illustrated in FIGS. 4 and 5 relates to the signal frequency. By varying the frequency between the signals, the primary and secondary signals may be distinguished. In the illustrated embodiments, the time scales are different, and the primary signal has a relatively short frequency (e.g. 700 microseconds) and the secondary signal has a relatively long frequency (e.g. 2 seconds). The illustrated frequencies are exemplary only.

An exemplary operation of the control panel 300 will be described below with reference to FIGS. 2-5. The controller 320 continuously pulses the primary and secondary signals to the touch sensitive elements 302 and the contaminant sensor element 304 with distinct pulsed signals having different signal characteristics. The controller 320 continuously polls and monitors the output signal 322 from touch sensitive elements 302. For example, the controller 320 may be constantly polling and monitoring the touch sensitive elements 302 for the output signals 322. Alternatively, the controller 320 may poll the touch sensitive elements 302 at regular intervals for the output signal 322. The signal characteristics of the output signal 322 represent the status of the panel 300, and the signal characteristics of the output signal 322 may be based on factors such as the signal characteristic of the primary signal, the signal characteristic of the secondary signal, a touch by a user, and contamination. For example, the output signal 322 may indicate that no touch event and no contamination are occurring at the panel 300. Such an output signal 322 may constitute a baseline signal to which other output signals are compared. Such an output signal 322 is based on the primary signal and may be identical to the primary signal, indicating that the primary signal is unchanged.

The output signal 322 may indicate an occurrence of a touch event at the touch sensitive element 302. For example, when a user touches the touch sensitive element 302, a capacitive circuit is created between the touch sensitive element 302 and the user. The capacitive circuit affects the primary signal sent to the touch sensitive element 302, and the output signal 322 is different than the baseline signal received when no touch is occurring. Such an output signal 322 is based on the primary signal and a touch event, but has a different signal characteristic than the baseline signal.

The output signal 322 may indicate an occurrence of a contamination or spill on the panel 300. Such an output signal 322 is based at least in part on the secondary signal, and has a different signal characteristic than the baseline signal. For example, when a contaminant 314 is present, a coupling path 316 is created between the contaminant sensor element 304 and the touch sensitive element 302. The secondary signal sent to the contaminant sensor element 304 is also received by the touch sensitive element 302 via the contaminant 314. As such, when the controller 320 detects that the output signal 322 is affected by the secondary signal, the controller 320 determines that a contamination has occurred. When a contamination has occurred, the controller 320 may operate the device in a different manner. For example, the controller 320 may alert or notify the user to such contamination, the controller 320 may disable the device, the controller 320 may reject an operation command from a user, and the like. As such, user intervention is not required to sense contamination. The controller 320 automatically detects when a contamination has occurred. Additionally, the controller 320 automatically detects if the contamination is removed, and may resume normal operation.

A touch sensitive control system for a device is provided which operates in an efficient and reliable manner. The control system includes a control panel 300 at the interface that operates using touch control technology. The panel 300 includes touch sensitive elements 302 that are surrounded by, but isolated from, a contaminant sensor element 304. The control system is able to determine when a contamination has occurred at the panel 300 by monitoring for contamination signals at the touch sensitive elements 302. Specifically, a controller 320 sends primary and secondary control signals to the elements 302, 304, and the controller 320 monitors output signals 322 sent from the touch sensitive elements 302. When the controller 320 detects output signals 322 having characteristics of the secondary control signals, the controller determines that a contamination has occurred and the contaminant has provided a coupling path between the normally isolated elements 302, 304. By providing primary and secondary control signals having different signal characteristics, the controller 320 is able to identify a contamination by monitoring only the touch sensitive elements 302, which may simplify the control system.

While the invention has been described in terms of various specific embodiments, those skilled in the art will recognize that the invention can be practiced with modification within the spirit and scope of the claims.

What is claimed is:

1. A touch sensitive control interface for a controlled device, said control interface comprising:
a panel defining an interface area configured to selectively input command instructions of an operator of the device, wherein the panel comprises a primary touch sensor portion configured to receive an activation signal and a secondary touch sensor portion configured to receive a contamination signal, the primary and secondary touch sensor portions being normally isolated from one another, and the primary and secondary touch sensor portions being coupled to one another upon a presence of a contaminant such that the primary touch sensor portion senses the contamination signal.

2. An interface in accordance with claim 1 wherein the activation signal and the contamination signal have different signal characteristics.

3. An interface in accordance with claim 2 wherein the signal characteristics of the activation signal and the contamination signal differ in at least one of a pattern, an amplitude, a frequency, a signal shape, a signal type, a signal width, a phase, and an interval between signals.

4. An interface in accordance with claim 1 wherein the activation signal and the contamination signal are pulsed.

5. An interface in accordance with claim 1 wherein the contaminant is configured to capacitively couple to each of the primary and secondary touch sensor portions.

6. An interface in accordance with claim 1 wherein the contaminant is configured to provide a coupling path between the primary and secondary touch sensor portions.

7. An interface in accordance with claim 1 wherein the panel further comprises a ground plane to electrically isolate the primary and secondary touch sensor portions.

8. An interface in accordance with claim 1 wherein the panel comprises multiple primary touch sensor portions, and wherein the panel further comprises a contaminant sensor element and a plurality of keypads, wherein each of the keypads comprise a corresponding one of the primary touch sensor portions and the contaminant sensor element comprises the secondary touch sensor portion.

9. An interface in accordance with claim 8 wherein the contaminant sensor element and the keypads are substantially coplanar, and the keypads are received in openings in the contaminant sensor element.

10. A touch sensitive control system for controlling a device, said control system comprising:
an interface comprising a touch sensitive element configured to receive an activation signal and a contaminant sensor element configured to receive a contamination signal, the contaminant sensor element being normally isolated from the touch sensitive element, and the contaminant sensor element being coupled to the touch sensitive element upon a presence of a contaminant overlapping each of the touch sensitive element and the contaminant sensor element, the touch sensitive element being configured to send an output signal being characterized by the activation signal when no contaminant is present and being characterized by both the activation signal and the contamination signal when a contaminant is present; and
a controller electrically connected to the touch sensitive element and receiving the output signal therefrom, the controller being operatively responsive to the output signal.

11. A control system in accordance with claim 10 wherein the controller is programmed to prevent actuation of the device when the output signal is characterized by both the activation signal and the contamination signal.

12. A control system in accordance with claim 10 wherein the activation signal and the contamination signal have different signal characteristics.

13. A control system in accordance with claim 10 wherein the signal characteristics of the activation signal and the contamination signal differ in at least one of a pattern, an amplitude, a frequency, a signal shape, a signal type, a signal width, a phase, and an interval between signals.

14. A control system in accordance with claim 10 wherein the contaminant is configured to capacitively couple to each of the touch sensitive element and the contaminant sensor element.

15. A control system in accordance with claim 10 wherein the contaminant is configured to provide a coupling path between the touch sensitive element and the contaminant sensor element.

16. A control system in accordance with claim 10 wherein the interface comprises multiple touch sensitive elements, and wherein the interface further comprises a contaminant sensor element and a plurality of keypads, wherein each of the keypads comprise a corresponding one of the touch sensitive elements and the contaminant sensor element comprises the contaminant sensor element.

17. A device having a touch sensitive control system, the device comprising:
an interface comprising a touch sensitive element configured to receive an activation signal and a contaminant sensor element configured to receive a contamination signal, the contaminant sensor element being normally isolated from the touch sensitive element, and the contaminant sensor element being coupled to the touch sensitive element upon a presence of a contaminant overlapping each of the touch sensitive element and the contaminant sensor element, the touch sensitive element being configured to send an output signal being characterized by the activation signal when no contaminant is present and being characterized by both the activation signal and the contamination signal when a contaminant is present;
a controller electrically connected to the touch sensitive element and receiving the output signal therefrom, the controller configured to send a control signal responsive to the output signal; and
an operating component operatively coupled to the controller and receiving the control signal.

18. A device in accordance with claim 17 wherein the controller signal prevents operation of the operating component when the output signal is characterized by both the activation signal and the contamination signal.

19. A device in accordance with claim 17 wherein the activation signal and the contamination signal have different signal characteristics.

20. A device in accordance with claim 17 wherein the signal characteristics of the activation signal and the contamination signal differ in at least one of a pattern, an amplitude, a frequency, a signal shape, a signal type, a signal width, a phase, and an interval between signals.
